(19) United States
(12) Patent Application Publication
(10) Pub. No.: US 2010/0329661 A1
(43) Pub. Date: Dec. 30, 2010

(54) Scouting Camera User Interface

(75) Inventor: Mark J. Cuddeback, Green Bay, WI (US)

Correspondence Address: JANSSON SHUPE & MUNGER LTD., 245 MAIN STREET, RACINE, WI, 53403, US

(73) Assignee: NON TYPICAL, INC., Green Bay, WI (US)

(21) Appl. No.: 12/826,869

(22) Filed: Jun. 30, 2010

Related U.S. Application Data
(60) Provisional application No. 61/221,963, filed on Jun. 30, 2009.

(51) Int. Cl. G03B 17/00

(52) U.S. Cl. 396/299

(57) ABSTRACT

A game scouting camera including a processing system having an operating system and a memory device and a user interface operably connected to the processing system that has (a) a visual display, (b) at least one operation key for inputting user commands, and (c) a multiple-stage manual switch movable to multiple alignment positions to control multiple camera functions during a camera setup procedure.

### RELATED APPLICATIONS

This application claims the benefit of provisional application Ser. No. 61/221,963 filed on Jun. 30, 2009.

### FIELD OF THE INVENTION

The invention relates to game animal scouting cameras and, more particularly, to user interfaces and corresponding methods of programming that are incorporated into game animal scouting cameras.

### BACKGROUND OF THE INVENTION

Game animal observation for recreation and/or for scouting in association with hunting activities is growing increasingly popular. Game animal observation or scouting activities can include implementation of scouting cameras for taking photographs, video footage, or other recordings. Use of scouting cameras for game animal observation or scouting is generally known.

Scouting cameras for scouting potential hunting areas and determining game patterns, particularly without disturbing animal activity, are generally well known in the art. Typically, the apparatus includes a film, digital or video camera and a passive infrared sensor (e.g., a motion/heat sensor) that is adapted to sense movement and, in response, activate the camera focused on the area in which the sensor detects movement. Oftentimes, these devices include a delay timer with multiple settings to match specific conditions or locations, thus eliminating unwanted multiple exposures or other non-desired events. Moreover, such apparatus preferably includes high/low sensitivity settings to allow adjustment of the camera's effective range in order to photograph or record game at a desired distance.

Known scouting cameras are set up or programmed by the user, typically, using relatively complex user interfaces and/or complex procedures. Many such scouting camera user interfaces include keypads that have five or more keys which are used to navigate through menus shown on a display and then set or define various operational parameters or values. With numerous menus to navigate through and numerous parameters or values to define, setting up and programming known scouting cameras can be confusing and can take a substantial amount of time. Setting up and programming some known scouting cameras is so complex that users take their operator's or instruction manuals with them to the field to use as references to guide them through such procedures. If such users are, for whatever reason, without their manuals, then they may experience great difficulty in setting up or programming their scouting cameras.

### OBJECTS OF THE INVENTION

It is the object of the present invention to provide a scouting camera user interface which addresses these shortcomings by overcoming the aforesaid problems of the prior art. It is an object of the present invention to provide a scouting camera user interface which is easy to use, compared to known scouting cameras, even in the field. It is a further object of the present invention to provide a scouting camera user interface which requires relatively few manipulations to program, activate, and control a scouting camera. Another object of the innovative scouting camera user interface is to enable a scouting camera to be fully programmable for numerous functions without requiring extensive keypad manipulation or manipulating numerous DIP (dual in-line package) switches. Yet another object of the present invention is to provide a scouting camera user interface with a multiple-stage switch, e.g., a rotary switch, and one or more operation keys.

### SUMMARY OF THE INVENTION

The present invention is a scouting camera which includes (i) a processing system having an operating system and a memory device and (ii) a user interface operably connected to the processing system and including: a visual display; at least one operation key for inputting user commands; and a multiple-stage manual switch that is moved to multiple alignment positions to control multiple camera functions during a camera setup procedure.

In some preferred embodiments of the innovative scouting camera, the multiple-stage manual switch defines a first range controlling a first category of camera functions and a second range controlling a second, different category of camera functions. In some such embodiments, the at least one operation key is used in combination with the multiple-stage manual switch to define a value that corresponds to a setting within one of the first and second categories of camera functions.

In some preferred embodiments, the multiple-stage manual switch alone is used to define a value that corresponds to a setting within the other one of the first and second categories of camera functions.

In other preferred embodiments, the first category of camera functions includes at least one of time and date settings, and the second category of camera functions includes picture-taking frequency settings. In some of these embodiments, the multiple-stage manual switch further defines a switch position corresponding to at least one of a test mode and a power-off setting.

In additional preferred embodiments of the innovative scouting camera, the at least one operation key includes a first operation key and a second operation key and the multiple-stage manual switch defines (a) a time position for setting a time value, (b) a date position for setting month and day values, and (c) a year position for setting a year value, at least one position of which is displayable on the visual display.

In other preferred embodiments, when the multiple-stage manual switch is located at the time position, the first operation key manipulates an hour value and the second operation key manipulates a minute value. In other such embodiments, when the multiple-stage manual switch is located at the date position, the first operation key manipulates a month value and the second operation key manipulates a day value. And yet other such embodiments, when the multiple-stage manual switch is located at the year position, manipulating the first operation key increases a year value displayed on the visual display and manipulating the second operation key decreases a year value.

In highly-preferred embodiments of the innovative scouting camera, the manual switch is a rotary switch.

The present invention also includes a method of operating a scouting camera, and such method includes performing an initial setup of the scouting camera by (a) determining a setting to define a value therefor, (b) aligning a multiple-stage rotary switch to a position that corresponds to the setting, (c) manipulating an operation key to define the value; and (d) activating the scouting camera. In some preferred embodiments of the innovative method, the scouting camera is automatically activated after performing the initial setup. Other preferred embodiments of the operation of a scouting camera further include determining a second setting to define a second value therefor and defining the second value by aligning the multiple-stage rotary switch to a position that corresponds to a desired value. In some such preferred embodiments, the second value is defined without manipulating the operation key.

Other preferred embodiments of the innovative method of operating a scouting camera comprise (a) rotating a multiple-stage rotary switch from a position corresponding to a power-off setting to a position within a first rotational range for controlling a first category of camera functions; (b) defining a first setting value within the first category of camera functions by manipulating an operation key; and (c) defining a second setting value within a second category of camera functions by rotating the multiple-stage rotary switch to a position within a second rotational range. In some of these preferred embodiments, the first category of camera functions includes time and date settings and the second category of camera functions includes picture-taking frequency settings. Other such embodiments further include (i) moving the multiple-stage rotary switch to a first discrete position within the first rotational range; (ii) manipulating the operation key to set a first time and/or date value; (iii) moving the multiple-stage rotary switch to a second discrete position within the first rotational range; (iv) manipulating the operation key to set a second time and/or date value; and (v) moving the multiple-stage rotary switch to a discrete position within the second rotational range to set a picture-taking frequency value.

In yet other preferred embodiments of the innovative method for operating a scouting camera, setting the picture-taking frequency value is performed without manipulating the operation key.

In additional embodiments of the innovative method, the scouting camera includes first and second operation keys and the multiple-stage rotary switch defining (a) a time position for setting a time value, (b) a date position for setting month and day values, and (c) a year position for setting a year value, at least one position of which is displayable on the visual display. In some of these preferred embodiments, the method further includes moving the multiple-stage rotary switch to a time position, manipulating the first operation key to set an hour value, and manipulating the second operation key to set a minute value. In other of these preferred embodiments, the method includes moving the multiple-stage rotary switch to a date position, manipulating the first operation key to set a month value, and manipulating the second operation key to set a day value. And in yet other of these embodiments, the method includes moving the multiple-stage rotary switch to a year position, manipulating the first operation key to increase a year value, and manipulating the second operation key to decrease a year value.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a perspective view of a first embodiment of a scouting camera.

FIG. 2 is a front elevational view of a programming interface of the scouting camera of FIG. 1.

FIG. 3 is a close-up front elevational view of the user interface of FIG. 2.

FIG. 4 is a flowchart illustrating a method of using the programming interface of the preferred embodiments.

### DETAILED DESCRIPTION OF PREFERRED EMBODIMENTS

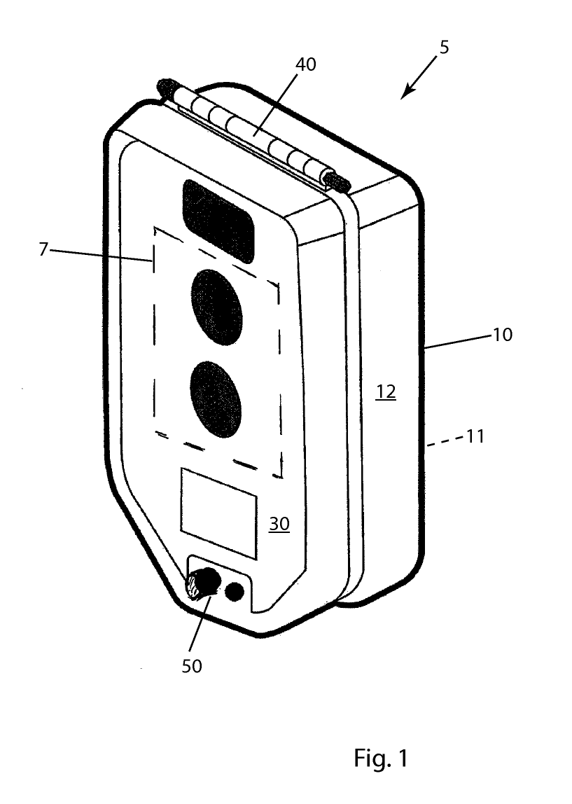

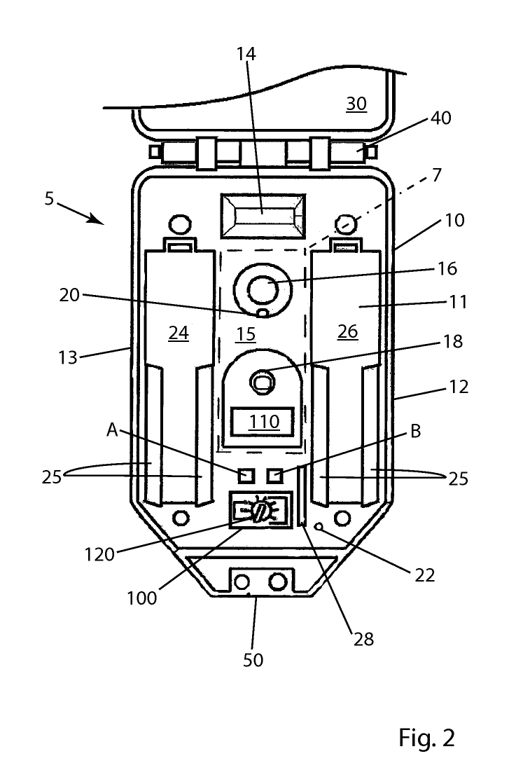

With initial reference to FIGS. 1 and 2, a scouting camera 5 is shown. Scouting camera 5 includes a processing system 7 that includes various known system resources such as, for example, a memory device, a processor, and an operating system (not shown specifically but in general) communicating with each other and configured to perform the desired functions of scouting camera 5. The scouting camera 5 further includes a main body 10 and a cover 30 that are joined together with a hinge 40 at a top portion of the main body 10. At a bottom portion of the main body 10, a lock assembly 50 is provided which includes a thumbscrew for temporarily holding the cover 30 against the main body 10 and a lock receptacle to receive a lock when securing the cover 30 against the main body 10.

Main body 10 is a box-like enclosure that has a back wall 11, multiple sidewalls 12, 13 extending therefrom, and a front wall 15. Front wall 15 holds an infrared illuminator 14, a camera window 16, and a sensor, such as a heat-in-motion sensor 18, vertically aligned with each other and extending down the middle of the front wall 15. Multiple LEDs (light emitting diodes) 20, 22 can be provided on the front wall 15 and can be configured to indicate feature or other statuses of scouting camera 5 or convey various other information to a user. A pair of battery bays 24, 26 are parallel to each other sitting adjacent the sidewalls 12, 13 and open into the main body 10 so that the back wall 11 serves as the back of the battery bays 24, 26 and the sidewalls 12, 13 define outer lateral walls of the battery bays 24, 26. Each of the battery bays 24, 26 has a pair of flanges 25 that extend outwardly from the front wall and across part of the opening of the bays 24, 26 to capture and retain batteries therein. A memory card slot 28 communicates with the processing system 7 and is provided near one of the battery bays 24, 26.

Cover 30 flips open and closed by pivoting about a hinge pin of the hinge 40, which is preferably configured to selectively hold the cover 30 in one or more open positions. The cover 30 has various openings that align with the IR illuminator 14, camera window 16, and heat-in-motion sensor 18 allowing such components to operate when the cover 30 is in the closed position, overlying the main body 10. When the cover 30 is in an open position, a user interface 100 is readily accessible to a user.

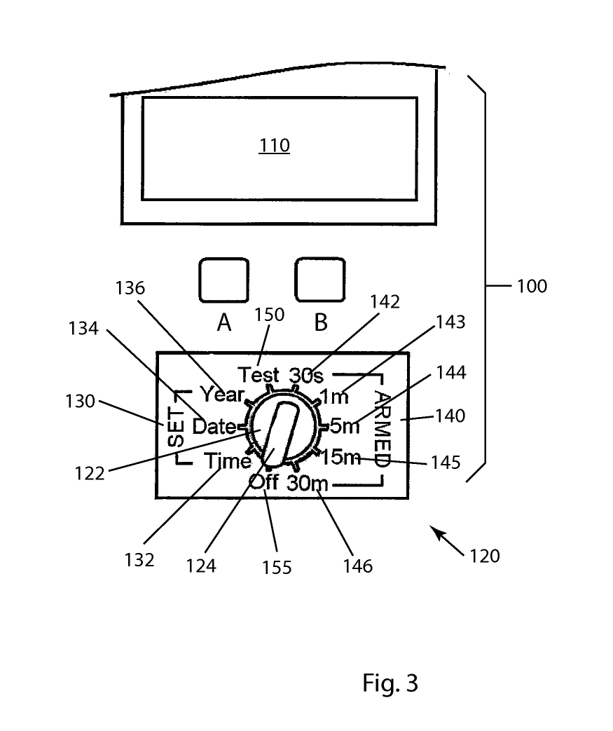

Referring now to FIGS. 2 and 3, user interface 100 is configured to perform numerous setup and programming functions by way of few user input devices and by using few steps. For example, the user interface 100 includes a visual display 110, a multiple-stage manually operable switch, such as a rotary switch 120, and a pair of operation keys “A” and “B”. (In FIG. 3, the labels “A” and “B” are associated with the two square keys located directly above such labels, respectively.) Visual display 110 can be an LCD (liquid crystal display) or other suitable known display device that communicates with the processing system 7 and conveys system status and/or other use-related information to the user.

Referring now to FIG. 3, multiple-stage rotary switch 120 has a base 122 and an arm 124 that visually indicates where the multiple-stage rotary switch 120 is pointing or what it is aligned with at any given time. Multiple stage rotary switch 120 is rotatable about an entire 360-degree range of circular movement. Within the full range of circular or rotational movement, the multiple-stage rotary switch 120 defines multiple rotational ranges that account for portions of the full rotational range. For example, a SET-range 130 defines a first rotational range for controlling a first category of camera functions, and an ARMED-range 140 defines a second rotational range for controlling a second category of camera functions.

SET-range 130 provides a control mechanism for a clock or calendar feature, allowing processing system 7 to, for example, time and date stamp photos when they are taken. SET-range 130 includes three distinct positions, namely, Time position 132, Date position 134, and Year position 136. ARMED-range 140 provides a control mechanism for picture-taking frequency, by controlling the scouting camera's five dwell times or periods of time that it waits or delays before taking another picture. ARMED-range 140 includes five distinct positions, namely, 30 s position 142, 1 m position 143, 5 m position 144, 15 m position 145, and 30 m position 146 which correspond to dwell times of thirty seconds, one minute, 5 minutes, fifteen minutes, and thirty minutes, respectively. The particular positions, number of positions, and types of camera functions that correspond to such positions are merely exemplary and non-limiting, noting that other camera functions can be controlled by way of multiple-stage rotary switch 120, depending on the particular desired end-use configuration of scouting camera 5.

Still referring to FIG. 3, in addition to the SET-range 130 and ARMED-range 140, multiple-stage rotary switch 120 can have other positions defined within its full rotational range. For example, Test position 150 and Off position 155 can be provided between the SET-range 130 and ARMED-range 140, optionally elsewhere within the full rotational range of the multiple-stage rotary switch 120. Operation keys “A” and “B” cooperate with the multiple-stage rotary switch 120 for controlling at least some of the functions of scouting camera 5 and/or inputting and defining various values; this portion of operation is described in greater detail elsewhere herein.

Referring now to FIGS. 1-3, in light of the above, to use the scouting camera 5, it is first mounted to a tree or other mounting substrate by way of a screw, strap, or other suitable hardware. Preferably, scouting camera 5 is mounted about three feet above the ground and about ten feet to fifteen feet, optionally up to about 50 feet, from a particular area where games animals are expected to be found. The multiple-stage rotary switch 120 is turned to the Off position 155, and batteries are installed into the battery bays 24, 26. Scouting camera 5 senses a charge or power value of the batteries and, if the batteries are low on power, then the same is conveyed to the user by, for example, showing a low-battery icon (not shown) on the visual display 110. In some embodiments, after batteries are installed in scouting camera 5, a series of numbers is shown on the visual display 110, revealing product and software information such as hardware and software version numbers, and then the visual display 110 powers down and scouting camera 5 remains off. A memory card (not shown) is inserted into the memory card slot 28 of scouting camera 5, and a setup procedure can begin by way of the user interface 100.

Referring again to FIG. 3, as part of the setup procedure, a preliminary test can be performed to check or confirm a detection zone of the scouting camera 5. The multiple-stage rotary switch 120 is moved to the Test position 150. Cover 30 is closed and then secured shut with the thumbscrew of the lock assembly 50. The user walks back and forth in front of scouting camera 5, and an LED 20 is illuminated, visible through an opening of the cover 30, when the user is detected by the scouting camera 5.

Still referring to FIG. 3, the setup continues by using the SET-range 130 for setting various time and date values. Namely, multiple-stage rotary switch 120 is moved to the Time position 132. When switch 120 is in the Time position 132, pressing the “A” operation key manipulates or sets an hour value and pressing the “B” operation key manipulates or sets a minute value. Next, multiple-stage rotary switch 120 is moved to the Date position 134. When switch 120 is in the Date position 134, pressing the “A” operation key manipulates or sets a month value and pressing the “B” operation key manipulates or sets a day value. Multiple-stage rotary switch 120 is then moved to the Year position 136. When switch 120 is in the Year position 136, pressing the “A” operation key decreases the year value and pressing the “B” operation key increases the year value.

Still referring to FIG. 3, the setup continues by using ARMED-range 140 for setting a picture-taking frequency or dwell time value for scouting camera 5. This can be done without manipulating the operation keys “A” and “B”, but instead by only using the multiple-stage rotary switch 120. The user decides which dwell time to implement and then moves multiple-stage rotary switch 120 to the corresponding one of the “30 s” position 142, “1 m” position 143, “5 m” position 144, and “15 m” position 145, and “30 m” position 146.

The dwell times can be selected based on the particular environment or habitat in which scouting camera 5 is installed and the type of animal activity that is expected at such location, in order to minimize a likelihood of taking multiple pictures of the same game animal(s). For example, 30 s position 142 establishes a relatively short dwell time of thirty seconds before the scouting camera 5 can take a subsequent picture after taking a first picture. A short dwell time of 30 seconds can be appropriate for a game animal trail location since an animal on such a trail is likely to quickly traverse it without loitering about 1 m position 143 establishes a somewhat longer dwell time of one minute, which can be appropriate for a game animal scrape location since, for example, a buck deer typically spends a relatively short amount of time making a scrape on the ground. The longer dwell times of five, fifteen, and thirty minutes of 5 m position 144, 15 m position 145, and 30 m position 146, respectively, can be appropriate for food plot or feed station locations where the game animals will likely remain for a relatively longer period of time.

After scouting camera 5 has been in use for a period of time, a user can check its picture status in the following way. Cover 30 is lifted open and the user can push either one of the operation keys “A” and “B” to temporarily suspend picture-taking function of the scouting camera 5. When operation key “A” or “B” is released, the number of images that are stored on the memory card is shown on the visual display 110. In some embodiments, pressing operation key “A” or “B” subsequent times will show the user yet other information on visual display 110. Such other information includes, but is not limited to, available storage space on the memory card, time, date and year. In some embodiments, after conveying all such information to the user, pressing operation key “A” or “B” another time will put scouting camera 5 into test mode, as though multiple-stage rotary switch 120 was moved to the Test position 150. Then after a period of inactivity, in other words, of not detecting anything in the test mode, scouting camera 5 automatically arms itself, returning it to picture-taking mode. Such period of inactivity is predetermined and can be, for example, two minutes, four minutes, five minutes, or some other time period. In some embodiments, after pressing operation key “A” or “B” a certain number of times, for example, four, five, or six times, optionally, two times in a rapid sequence, then scouting camera 5 again arms itself, returning to picture-taking mode.

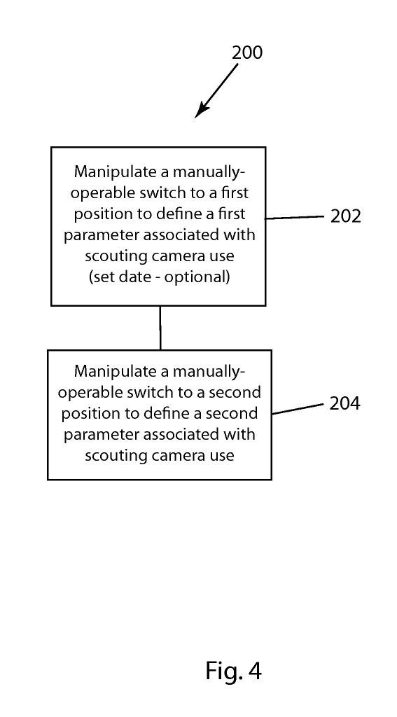

Turning to FIG. 4, a method 200 of programming a scouting camera using the above-described user interface is shown. Beginning with the switch of the user interface in Off position 155, the user can first actuate the manually operable switch to a first position in Block 202 of FIG. 4, and possibly to multiple positions, to set the current year, date and time. Once set, switch 120 can be used to turn scouting camera 5 off, as described above, or to arm camera 5. To arm scouting camera 5, the user manipulates switch 120 to a second position to define a parameter associated with scouting camera 5 use in Block 204. For instance, camera 5 can be armed for a range of “dwell” times. As described previously, the user may want to minimize the number of shots of the same animal and can do so by making sure that scouting camera 5 cannot re-arm itself for a period of time (the dwell time). For instance, if the user selects one minute, once a subject is identified and a picture is taken, another picture cannot be taken for another minute. In sum, once the year, date and time are set on the user's camera, the user simply needs to arm scouting camera 5 with a particular dwell time to place the camera into action. This simple one-step programming of scouting camera 5 with a manually-operable switch provides far superior ease-of-use over all known scouting cameras.

While the principles of this invention have been described in connection with specific embodiments, it should be understood clearly that these descriptions are made only by way of example and are not intended to limit the scope of the invention.

1. A scouting camera, comprising:
a processing system having an operating system and a memory device; and
a user interface operably connected to the processing system and including:
(a) a visual display; (b) at least one operation key for inputting user commands; and (c) a multiple-stage manual switch movable to multiple alignment positions to control multiple camera functions during a camera setup procedure.

2. The scouting camera of claim 1 wherein the multiple-stage manual switch defines a first range controlling a first category of camera functions and a second range controlling a second, different category of camera functions.

3. The scouting camera of claim 2 wherein the at least one operation key is used in combination with the multiple-stage manual switch to define a value that corresponds to a setting within one of the first and second categories of camera functions.

4. The scouting camera of claim 3 wherein the multiple-stage manual switch alone is used to define a value that corresponds to a setting within the other one of the first and second categories of camera functions.

5. The scouting camera of claim 2 wherein:
the first category of camera functions includes at least one of time and date settings; and
the second category of camera functions includes picture-taking frequency settings.

6. The scouting camera of claim 5 wherein the multiple-stage manual switch further defines a switch position corresponding to at least one of a test mode and a power-off setting.

7. The scouting camera of claim 2 wherein the at least one operation key includes a first operation key and a second operation key and the multiple-stage manual switch defines (a) a time position for setting a time value, (b) a date position for setting month and day values, and (c) a year position for setting a year value, at least one position of which is displayable on the visual display.

8. The scouting camera of claim 2 wherein when the multiple-stage manual switch is located at the time position, the first operation key manipulates an hour value and the second operation key manipulates a minute value.

9. The scouting camera of claim 2 wherein when the multiple-stage manual switch is located at the date position, the first operation key manipulates a month value, and the second operation key manipulates a day value.

10. The scouting camera of claim 2 wherein when the multiple-stage manual switch is located at the year position, manipulating the first operation key increases a year value displayed on the visual display and manipulating the second operation key decreases a year value.

11. The scouting camera of claim 1 wherein the manual switch is a rotary switch.

12. A method of operating a scouting camera, the method including performing an initial setup of the scouting camera by (a) determining a setting to define a value therefor, (b) aligning a multiple-stage rotary switch to a position that corresponds to the setting, (c) manipulating an operation key to define the value, and (d) activating the scouting camera.

13. The method of claim 12 wherein the scouting camera is automatically activated after performing the initial setup.

14. The method of claim 12 further including determining a second setting to define a second value therefor and defining the second value by aligning the multiple-stage rotary switch to a position that corresponds to a desired value.

15. The method of claim 14 wherein the second value is defined without manipulating the operation key.

16. A method of operating a scouting camera, comprising:
rotating a multiple-stage rotary switch from a position corresponding to a power-off setting to a position within a first rotational range for controlling a first category of camera functions;
defining a first setting value within the first category of camera functions by manipulating an operation key; and
defining a second setting value within a second category of camera functions by rotating the multiple-stage rotary switch to a position within a second rotational range.

17. The method of claim 16 wherein the first category of camera functions includes time and date settings and the second category of camera functions includes picture-taking frequency settings.

18. The method of claim 17 further including:
moving the multiple-stage rotary switch to a first discrete position within the first rotational range;
manipulating the operation key to set a first time and/or date value;
moving the multiple-stage rotary switch to a second discrete position within the first rotational range;
manipulating the operation key to set a second time and/or date value; and
moving the multiple-stage rotary switch to a discrete position within the second rotational range to set a picture-taking frequency value.

19. The method of claim 18 wherein setting the picture-taking frequency value is performed without manipulating the operation key.

20. The method of claim 17 wherein the scouting camera includes first and second operation keys and the multiple-stage rotary switch defines (a) a time position for setting a time value, (b) a date position for setting month and day values, and (c) a year position for setting a year value, at least one position of which is displayable on the visual display.

21. The method of claim 20 further including moving the multiple-stage rotary switch to a time position, manipulating the first operation key to set an hour value, and manipulating the second operation key to set a minute value.

22. The method of claim 20 further including moving the multiple-stage rotary switch to a date position, manipulating the first operation key to set a month value, and manipulating the second operation key to set a day value.

23. The scouting camera of claim 20 further including moving the multiple-stage rotary switch to a year position, manipulating the first operation key to increase a year value, and manipulating the second operation key to decrease a year value.
